(19) United States
(12) Patent Application Publication
(10) Pub. No.: US 2022/0369023 A1
(43) Pub. Date: Nov. 17, 2022

(54) VIRTUAL REALITY HEADSET WITH FOLDABLE HEAD STRAPS

(71) Applicant: Jie Gui, Shenzhen (CN)

(72) Inventor: Jie Gui, Shenzhen (CN)

(21) Appl. No.: 17/321,361

(22) Filed: May 14, 2021

(51) Int. Cl. H04R 1/10; G06F 1/16

(52) U.S. Cl. CPC H04R 1/1066; H04R 1/1008; H04R 1/105; G06F 1/163; H04N 13/344

(57) ABSTRACT

The present invention relates to a totally foldable head strap. The virtual reality headset comprises of headphone bracket, back head member, front head, and head mounted display all of which can be rotatably connected and can be folded to reduce the carry and storing size. The head mounted display has two supporting bars that slide and snap inside the bar supports each attached at the front ends of the back head member. The front head member and back head member are rotatably connected from the inner side of the back head member.

### FIELD OF THE INVENTION

The present invention relates to headset and more particularly to a virtual reality headset with foldable straps.

### BACKGROUND OF THE INVENTION

A virtual reality headset is a head mounted device that provides virtual reality experience for the wearer. Virtual reality headsets are widely used with video games but they are also used in other applications, including simulators and trainers. Virtual reality headsets comprise a stereoscopic head-mounted display (providing separate images for each eye), stereo sound, and head motion tracking sensors which may include gyroscopes, accelerometers, magnetometers, structured light systems etc. Some VR headsets also have eye tracking sensors and gaming controllers.

Virtual reality is the use of computer technology to create a simulated environment. Unlike traditional user interfaces, VR places the user inside an experience. Instead of viewing a screen in front of them, users are immersed and able to interact with 3D worlds.

Virtual Reality's most immediately-recognizable component is the head-mounted display (HMD). Human beings are visual creatures, and display technology is often the single biggest difference between immersive Virtual Reality systems and traditional user interfaces.

### SUMMARY OF THE INVENTION

The present invention relates to a totally foldable head strap. More specifically, the back head, front head and the headphone bracket are all rotatable and foldable. Once the headset is folded it reduces the carry size largely and make the total VR device more portable.

In an embodiment of the present invention, the virtual reality headset comprises of headphone bracket, back head member, front head, and head mounted display all of which can be rotatably connected and can be folded to reduce the carry and storing size of headset.

The headphone bracket, back head member and front head member rotated and folded towards the rear end such that they lie in adjacent orientation to each other. The head mounted display is attached to the front side of the virtual reality headset.

In an embodiment of the present invention, the head mounted display unit has two supporting bars that slide and snap inside the bar supports each attached at the front ends of the back head member.

In an embodiment of the present invention, the virtual reality headset worn by user wherein the user can unfold the headphone bracket, back head member and front head member and adjust the device accordingly to make it rest on head with back head member gripping at the back of head providing virtual reality experience through two screen display of head mounting display unit.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 illustrates a side view of foldable virtual reality headset with headphone bracket open in accordance with the embodiments of the present invention;

FIG. 2 illustrates a side view of foldable virtual reality headset with headphone bracket folded in accordance with the embodiment of the present invention;

FIG. 3 illustrates a top view of foldable virtual reality headset with headphone brackets folded in accordance with an embodiment of the present invention.

FIG. 4 illustrates an exploded top view embodiment of virtual reality headset with headphone brackets folded in accordance with an embodiment of the present invention;

FIG. 5 illustrates an exemplary embodiment of virtual reality headset with foldable straps worn by user;

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

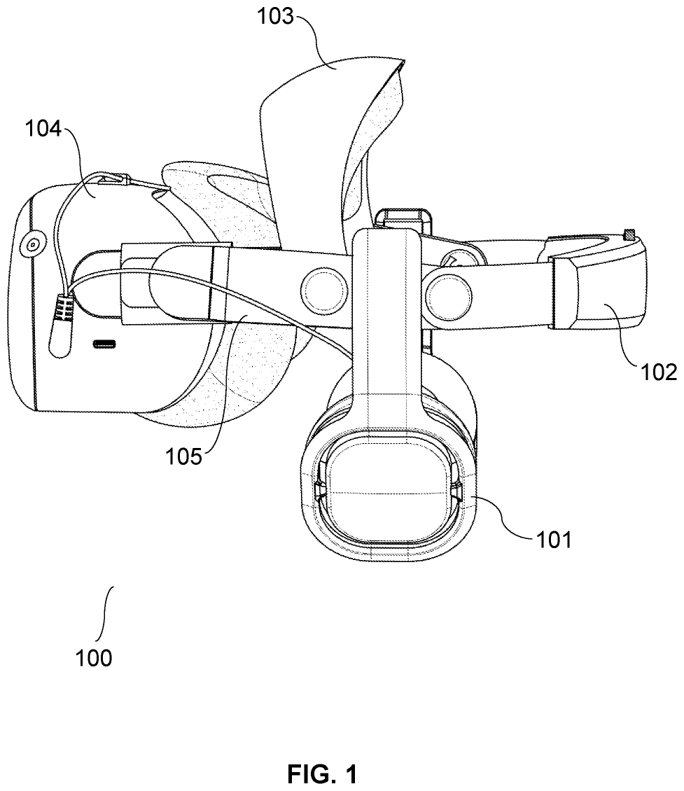

With reference now to the drawings, and in particular to FIG. 1 to FIG. 5 hereof, a foldable virtual reality headset embodying the principles and concepts of the present invention is described.

Reference is made now to FIG. 1, illustrating an embodiment 100 of the virtual reality headset comprising headphone bracket 101, back head member 102, front head 103 and head mounted display all of which are rotatably connected and can be folded to reduce the carry and storing size of headset. The whole point of Virtual Reality Headset is to immerse the user in a new world. However, other than the VR headset, there are also many other parts necessary for Virtual Reality to actually work. For certain Virtual Reality Headsets, a console or computer is needed for the headsets to work. Video is sent from the console or the computer to the Virtual Reality Headset.

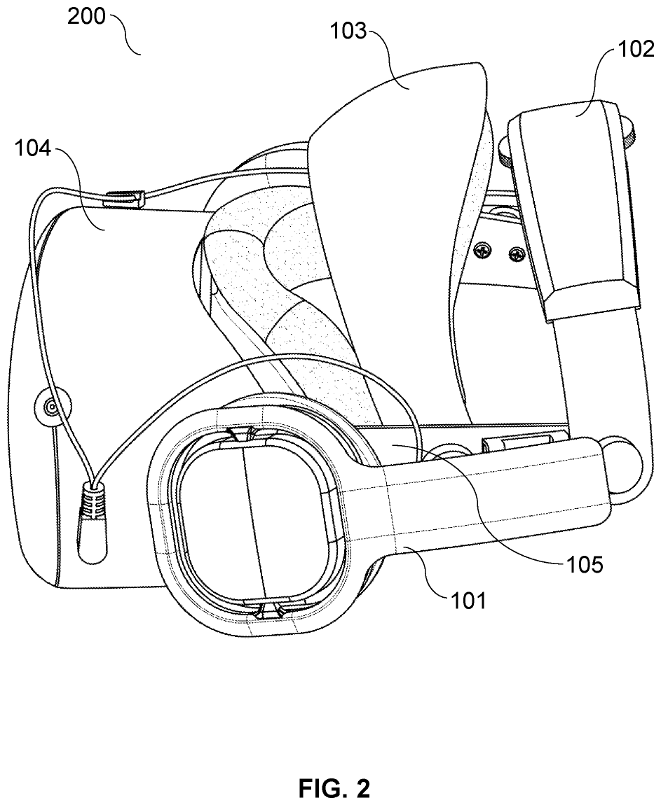

Reference is made now to FIG. 2, illustrating embodiment 200 of the virtual reality headset with headphone bracket 101 and back head member 102 in folded orientation to save space while keeping the virtual reality headset on desk or stand. The headphone bracket 101, front head member 103, back head member 102, and are rotatably connected to supporting member 105.

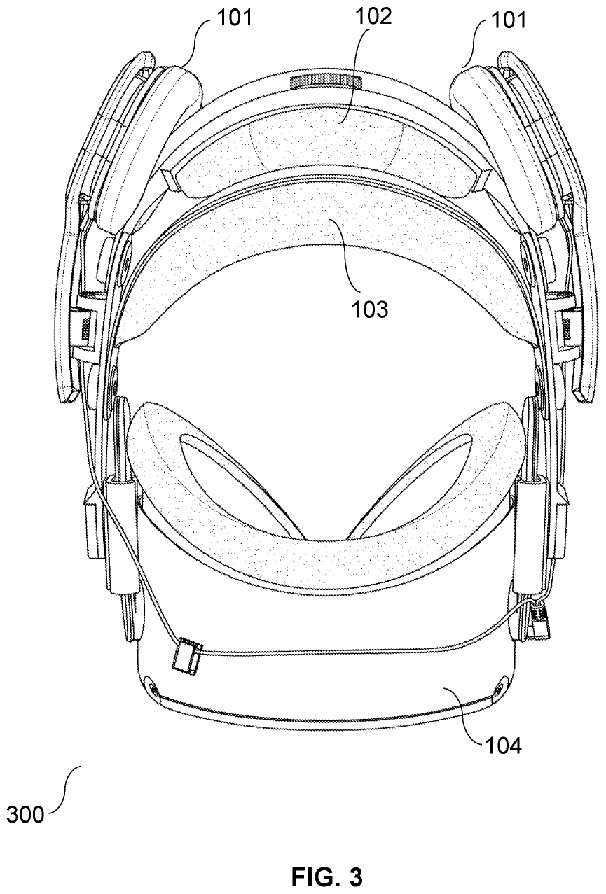

Reference is made now to FIG. 3, illustrating embodiment 300 of the virtual reality headset with headphone bracket 101, back head member 102 and front head member 103, rotated and folded towards the rear end such that they lie in adjacent orientation to each other. The head mounted display 104 is attached to the front side of the virtual reality headset. The front head member and back head member are rotatably connected from the inner side of the back head member.

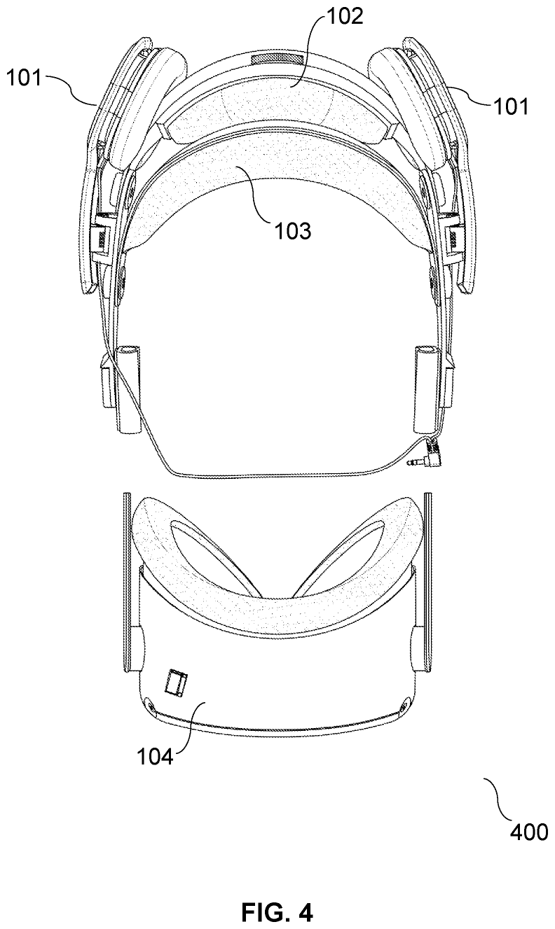

Reference is made now to FIG. 4, illustrating exploded embodiment 400 of the virtual reality headset wherein the head mounted display has two supporting bars that slide and snap inside the bar supports each attached at the front ends of the back head member (as shown in FIG. 3). The structure can be compacted by rotating and folding the back head member, front head member, and headphone bracket towards rear end of the foldable strap.

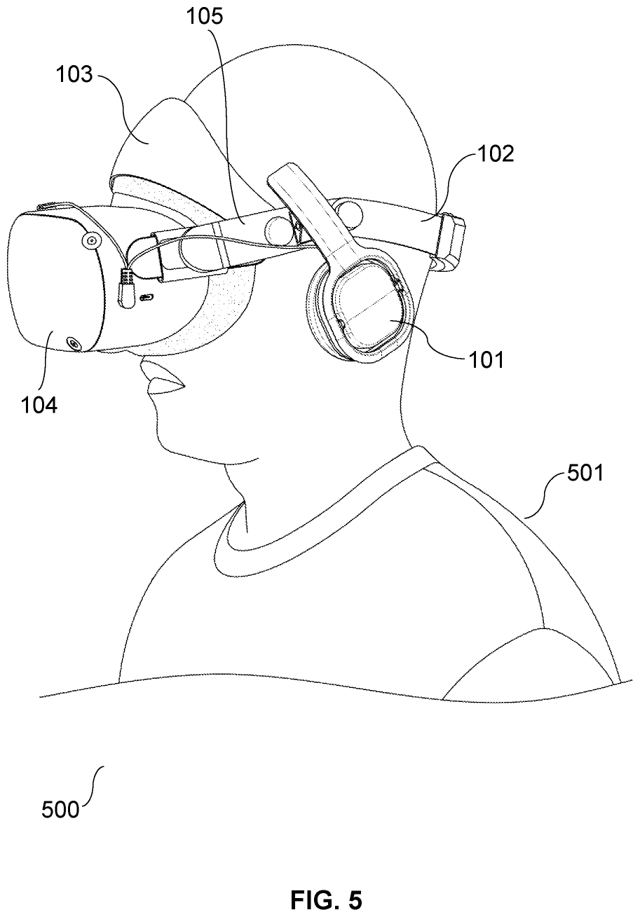

Reference is made now to FIG. 5, illustrating an exemplary embodiment 500 of the virtual reality headset worn by user wherein the user can unfold the headphone bracket 101, back head member 102, and front head member 103 and adjust the device accordingly to make it rest on head with back head member gripping at the back of head, headphone bracket covering the ears and the head mounted display 104 providing virtual reality experience through two screen display slightly different, stereoscopic images, creating a realistic 3D perspective of the virtual world. Head mounted displays also have built-in accelerometers or position sensors so they can detect exactly how your head and body are moving (both position and orientation—which way they are tilting and pointing) and adjust the picture accordingly. Virtual Reality Headsets use two LCD displays (one per eye) or two feeds sent to one display. Headsets also have lenses placed between your eyes and the screen, which are used to focus and reshape the picture for one each eye. They create a stereoscopic 3D image by angling the two 2D images. This because the lenses mimic how each of the two eyes the see the world very slightly differently.

The problem with most virtual reality headsets is that they are quite heavy and inconvenient to store. The present invention provides a virtual reality headset with rotatable straps that can be rotated and folded to make the structure and reduce the carry size.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular embodiment specifically contemplated, is intended to be practiced in the absence of any element which is not specifically disclosed herein.

1. A virtual reality headset comprising:
a headphone bracket, back head member, front head member rotatably connected to a supporting member such that the virtual reality headset can be folded by rotating the headphone bracket, back head member and front head member to rear side of the virtual reality headset.

2. A virtual reality headset according to claim 1, wherein the head mounting display of the virtual reality headset comprises two supporting bars that slide and snap inside the bar supports each connected at the front ends of the back head member.

3. A virtual reality headset according to claim 1, wherein the front head member and back head member are rotatably connected from the inner side of the back head member.

4. A virtual reality headset according to claim 1, wherein the headphone bracket is attached to supporting member by a spring mechanism for better adjustability of audio brackets over the ears.
